(19) United States
(12) Patent Application Publication
(10) Pub. No.: US 2006/0080423 A1
(43) Pub. Date: Apr. 13, 2006

(54) System and method for a printer access point

(76) Inventors: James Brewer, Leander, TX (US); John Medica, Austin, TX (US)

Correspondence Address: HAMILTON & TERRILE, LLP, P.O. BOX 203518, AUSTIN, TX, 78720, US

(21) Appl. No.: 10/862,684

(22) Filed: Jun. 7, 2004

(51) Int. Cl. G06F 15/173

(52) U.S. Cl. 709/223

(57) ABSTRACT

Deploying a wireless local area network of plural information handling systems interfaced with each other and a printer is simplified by integrating printing and networking components in a common housing. For instance, a wireless access point, print server, router and modem are disposed in a printer housing and powered by a common power source. An installation package provided on a portable storage medium, such as a CD or DVD, includes drivers and applications that support interaction of information handling systems with the printer and networking components. The installation package reduces complexity associated with configuration of a wireless local area network by presenting an interface that substantially simultaneously installs drivers and applications for printer and networking components on networked information handling systems.

### BACKGROUND OF THE INVENTION

1. Field of the Invention

The present invention relates in general to the field of information handling system printers and networks, and more particularly to a system and method for combining a printer and wireless access point within a common housing.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with a number of peripherals to communicate, print or otherwise process information. For instance, electrophotographic printers, such as laser or LED printers, and ink jet are typically used to print information, such as documents and photographs. As another example, external modems and routers are used to support network communications, both in wide and local area configurations. Typically, various types of cables interconnect information handling systems to peripherals and to each other, often in a Local Area Network (LAN) architecture. Businesses having a number of networked information handling systems and peripherals tend to route the various cables through walls and ceilings in order to protect the cables and to prevent the cables from interfering with working conditions. In contrast, homes and small businesses usually have insufficient resources to route cables out of sight. Instead, an increasing number of homes and small businesses are choosing to network information handling systems and peripherals with wireless networks, such as 802.11 b and g compliant networks. Thus, for instance, a single peripheral, such as a printer or modem, can support plural information handling systems by communicating information through a wireless network without having to go through the cost and trouble of stringing cables.

Although wireless networking greatly reduces the burden of setting up a home network by reducing the need for cables, a number of difficulties exist for individuals and small businesses desiring to set up a wireless network. For instance, each information handling system interfaced with a wireless network has to have networking software with correct configuration settings and appropriate drivers loaded to support interaction with networked peripherals. As one example, in order to interface a printer to several information handling systems through a wireless network, an individual typically must install printer, printer server, and communications applications and drivers on each information handling system and then configure each operating system to recognize the networking peripherals, such as a wireless access point, a router and a modem. Such a network configuration generally entails the installation of multiple applications from multiple CD's and complex operating system adjustments. Even tech-savvy individuals often have difficulty configuring peripherals of different types and from different manufactures to operate in a compatible manner. As a result, information handling system manufacturers have seen an increase in the number of technical support calls by individuals and small businesses that are related to network set up. Technical support, especially support provided by telephone or on-site visits, tends to be costly and substantially cuts into the profits of selling information handling systems into the home and small business markets.

### SUMMARY OF THE INVENTION

Therefore a need has arisen for a system and method which simplifies configuration of networked information handling systems and peripherals.

In accordance with the present invention, a system and method are provided which substantially reduce the disadvantages and problems associated with previous methods and systems for configuration of networked information handling systems and peripherals. Printing and networking wireless access point components are disposed in a common housing that supports simplified wireless network configuration.

More specifically, a printer and networking devices, such as a wireless access point, router and modem, are disposed in a common housing. A common power source has one AC power cord to supply the printer and networking devices. An installation package stored on a removable storage medium runs on one or more information handling systems to install applications and drivers that support communication with the printer and networking devices, such as through a local area network supported by the wireless access point. The installation package installs the drivers and applications in a substantially simultaneous manner to aid in component compatibility and reduce the complexity of the configuration process by providing a single application interface to manage the configuration of diverse devices. In one embodiment, the networking devices are selectively removable and insertable to support modular manufacture and distributed use of the networking devices, such as elevation of the access point antenna to improve reception.

The present invention provides a number of important technical advantages. One example of an important technical advantage is the combination of printer and networking functionality within a common housing so that installation of networking and printing drivers and applications are simplified with a single CD. The common housing reduces the number of data and power connections when compared with networks having separate networking and printing peripherals, and thus reduces the number of required cables. Installation of software from a single CD simultaneously covers all devices within the common housing, such as the printer, the print server, the access point and the router, to reduce the complication of installation compared with separate installations of individual devices. Integration of networking and printing devices reduces manufacturing cost and enhances the user experience by reducing the space taken up within a user's home or small business. Additionally, periodic ink jet printer cleaning functions that call for constant power to the printer occur on a more regular schedule when the printer is combined with networking components that users generally leave powered up, such as access points, routers and modems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a wireless local area network support by a printer access point;

FIG. 2 depicts a rear view of a laser printer having integrated wireless networking components; and

FIG. 3 depicts a rear view of an ink jet printer having integrated modular networking components.

### DETAILED DESCRIPTION

Wireless local area network configuration for interfacing information handling systems and a networked printer is simplified by incorporating networking components with the printer in a common housing. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

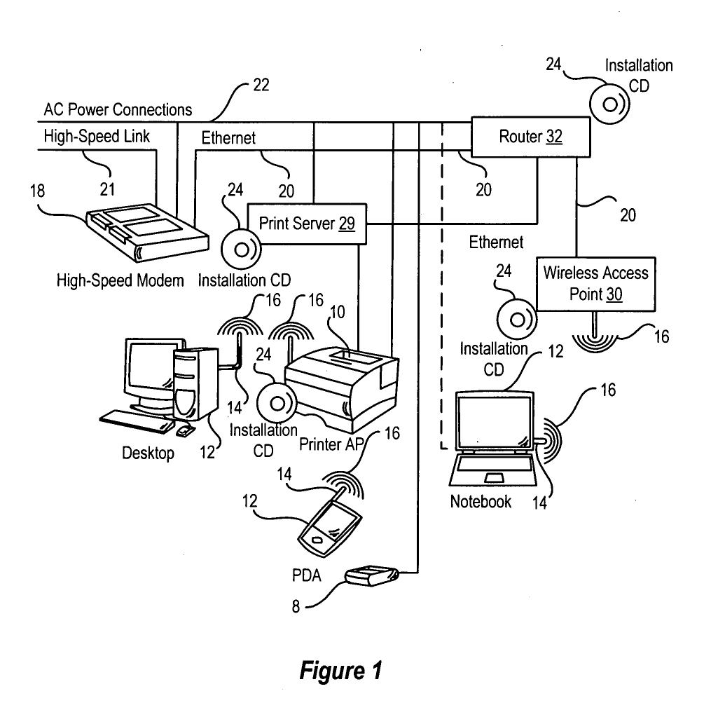

Referring now to FIG. 1, a block diagram depicts a wireless local area network supported by a printer access point 10. Information handling systems 12, such as desktop, portable and PDA systems, communicate information through wireless network components 14, such as network cards or imbedded networking devices, over a wireless local area network 16. An external high speed modem 18, such as a broadband DSL or cable modem, interfaces with external networks, such as through the Internet. Information is communicated between modem 18 and printer access point 10 through an Ethernet cable 20. Printer access point 10 includes router 32 and wireless access point 30 that support communication between information handling systems 12 and modem 18. A print server 29 interfaces with printer access point 10, such as though a USB, parallel or other printer cable, to manage print requests from multiple information handlings systems 12. Modem 18, information handling systems 12, PDA charging base 8, print server 29 and printer access point 10 receive power from an AC power connection 22. A single power cable to the printer and networking components of printer access point 10 reduces the number of cables in the network and encourages the user to maintain power to the printer, a factor helpful to life expectancy of ink jet printers that need power for periodic cleaning functions. Though power is maintained to printer AP 10, it may automatically be put into a low power state if unused for a specified interval of time, say one hour.

Local area network 16 communicates information in a conventional manner, such as in a configuration supported by the WINDOWS™ operating system or other networking applications. An installation portable storage medium, such as installation CD 24, aids efficient configuration of printer access point 10 to support wireless local area network 16 by installing drivers and applications on each information handling systems 12 for communicating with the printing and networking components of printer access point 10, such as print server 29, wireless access point 30 and router 32. Installation CD 24 is prepared at manufacture of printer access point 10 to include an installation package tailored for the integrated printer and networking components. The installation package streamlines each component's installation and the configuration of the network by reducing the need to address complex unit interconnections in hardware and software since the identity and compatibility are known for the components of printer access point 10. Installation on an information handling system 12 of the printing and networking drivers and applications occurs in a substantially simultaneous manner since the drivers and setup details are consolidated and the installation process knows how the printer and networking devices are to be initiated for communication over local area network 16. Installation CD 24 loads all printer, print server, access point and router drivers with the first information handling system 12 of the network and then, on subsequent information handling systems, installation CD 24 installs appropriate drivers to access the networking and printer components.

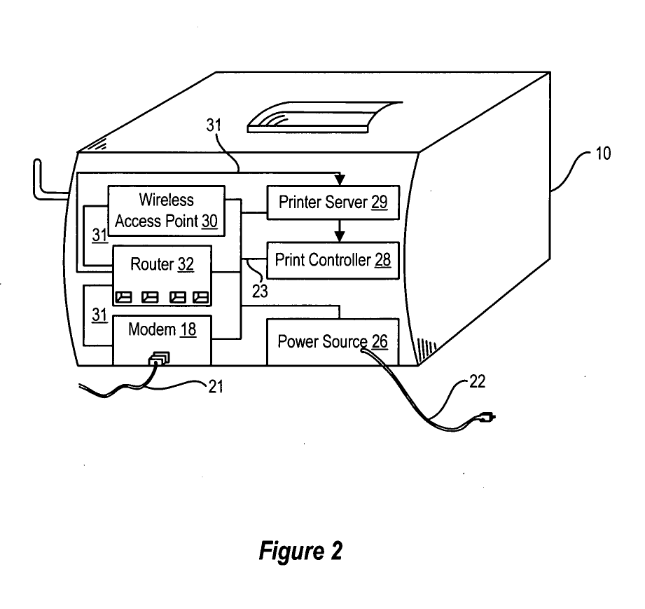

Referring now to FIG. 2, a rear view of a printer access point 10 depicts a laser printer having integrated networking components. A single power source converts AC power from power cable 22 into DC power through bus 23 for use by a print controller 28, print server 29, wireless access point 30, router 32 and modem 18. A single data cable 21 connects the modem to a broadband DSL or cable network, with internal communication between print controller 28, print server 29, wireless access point 30, router 32 and modem 18 supported by an internal bus 31. Print controller 28 is a processor and software that controls the printer engine and paper path and takes input text or images to create a dot mapping for the printer's engine to print onto media, such as paper, at various resolutions, in dot size, and in grey levels, such as 300 dpi to 1200 dpi, varying size, or different levels of color. Print server 29 sits between information handling systems networked by wireless access point 30 and print controller 28 to intercept prints jobs going to the printer and insure that multiple print jobs are sequenced so that print controller 28 only gets data from one print job at a time. Print server 29 is, for instance, dedicated hardware that attaches to the printer to perform this sequencing function or software that runs on print controller 28 to drive the printer. Print server 29 may have associated memory so that multiple jobs can be accepted and prioritized for sending to the print controller 28. Wireless access point 30 establishes a wireless local area network to communicate information between information handling systems and with print server 29. Modem 18 establishes communication with external networks and interfaces with router 32 to allow routing of information to local area network information handling systems through wireless access point 30.

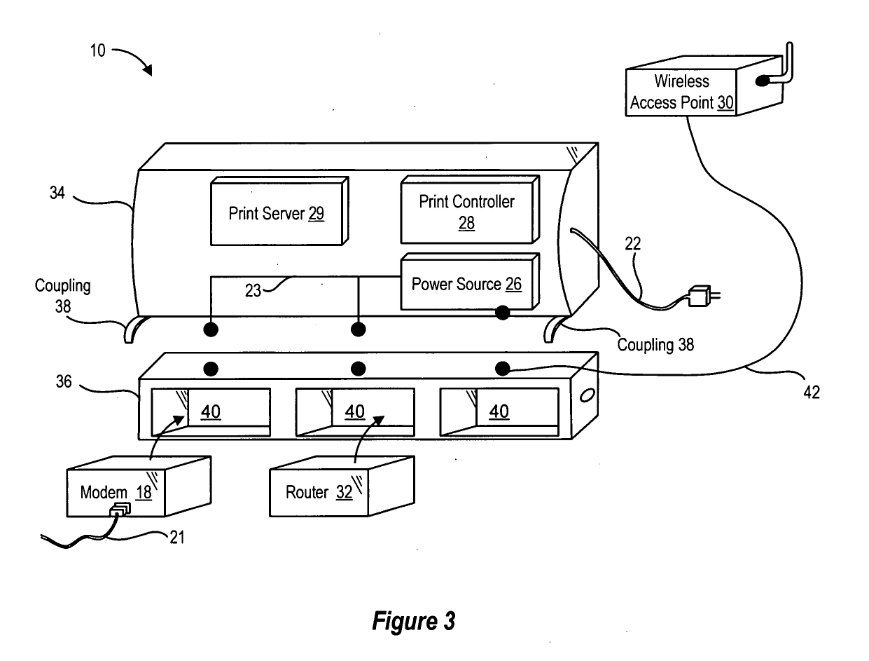

Referring now to FIG. 3, a printer access point 10 having an ink jet printer and a modular construction of networking components is depicted. An ink jet printer housing 34 couples to a modular network component housing 36 with removable couplings 38. Modem 18, router 32 and wireless access point 30 are selectably insertable into and removable from openings 40 formed in housing 36 so that pre-aligned electrical connections provide power and communication interfaces. The modular construction provides increased flexibility at manufacture for integrating different types of components built to a customer's order. In addition, users have greater flexibility to deploy modular components after initial configuration. For instance, a user may interface wireless access point 30 with housing 36 by a cable 42 so that wireless access point 30 is elevated to improve wireless connectivity.

Although the present invention has been described in detail, it should be understood that various changes, substitutions and alterations can be made hereto without departing from the spirit and scope of the invention as defined by the appended claims.

What is claimed is:

1. An information handling system peripheral comprising:
a housing;
a printer disposed in the housing, the printer operable to accept information from an information handling system and print the information on a print medium; and
a wireless access point disposed in the housing and interfaced with the printer, the wireless access point operable to network the printer and one or more information handling systems in a wireless local area network.

2. The information handling system peripheral of claim 1 further comprising a router disposed in the housing and interfaced with the wireless access point, the router operable to network the wireless local area network with one or more external networks.

3. The information handling system of claim 2 further comprising a modular print server disposed in the housing and interfaced with the wireless access point, the print server operable to schedule prints received through the wireless local area network.

4. The information handling system peripheral of claim 2 further comprising a modular modem disposed in the housing and interfaced with the router, the modem operable to communicate over a medium with the external networks.

5. The information handling system peripheral of claim 2 further comprising a single power source operable to power the printer, the wireless access point and the router.

6. The information handling system peripheral of claim 2 further comprising a portable storage medium having instructions that install the printer, access point and router in a substantially simultaneous operation.

7. The information handling system of claim 1 wherein the access point comprises a module selectively removable and insertable into the housing.

8. The information handling system of claim 7 wherein the access point module is capable of operation independent of and distal from the housing.

9. The information handling system of claim 1 further comprising a router, printer server and modem, wherein the access point, router, print server and modem fixedly integrated in the housing.

10. The information handling system peripheral of claim 1 wherein the printer comprises an electrophotographic printer.

11. The information handling system of claim 10 wherein the electrophotographic printer is a laser printer.

12. The information handling system peripheral of claim 1 wherein the printer comprises an ink jet printer.

13. A method for networking information handling systems and peripherals, the method comprising:
integrating a printer and a wireless access point into a housing;
consolidating drivers and installation applications for the printer and wireless access point in an installation package; and
running the installation package on an information handling system to bring the information handling system in operable communication with the wireless access point and the printer in a local area network.

14. The method of claim 13 wherein the installation package further comprises a printer server operable interface plural information handling systems with the printer through the local area network, the method further comprising:
running the installation package on one or more additional information handling systems; and
interfacing the additional information handling systems with the printer through the local area network.

15. The method of claim 13 further comprising:
integrating a router in the housing with the printer and the wireless access point;
consolidating drivers and installation applications for the router with the drivers and installation applications for the printer and wireless access point in the installation package; and
running the installation package on the information handling system to bring the router in operable communication with the wireless access point to support communication of information received from outside the local area network to the information handling system.

16. The method of claim 15 further comprising:
integrating a modem in the housing with the printer, the wireless access point and the router;
consolidating drivers and installation applications for the modem with the drivers and installation applications for the printer, wireless access point and router in the installation package; and
running the installation package on the information handling system to bring the modem in operable communication with the router to support communication with one or more networks external to the local area network.

17. The method of claim 15 wherein consolidating further comprises storing the installation package on a portable storage medium operable to install the drivers in a substantially simultaneous manner.

18. The method of claim 15 further comprising:
powering the wireless access point and the printer from a common power source.

19. The method of claim 13 further comprising:
detaching the wireless access point antenna from the printer;
interfacing the wireless access point to power provided from the printer; and
elevating the wireless access point antenna above the printer.

20. An information handling system network comprising:
plural information handling systems having wireless access cards operable to access a wireless network;
a housing;
a wireless access point disposed in the housing, the wireless access point operable to interface with the wireless access cards as a local area network; and
a printer disposed in the housing and interfaced with the wireless access point, the printer operable to accept information from one or more of the information handling systems through the local area network and to print the information on a medium.

21. The information handling system network of claim 20 further comprising a portable storage medium having an installation package operable to substantially simultaneously install drivers for the wireless access point and printer on an information handling system.

22. The information handling system network of claim 21 wherein the installation package is further operable to substantially simultaneously install a printer server, the printer server operable to manage requests to the printer from plural information handling systems.

23. The information handling system network of claim 20 further comprising:
a modem disposed in the housing, the modem operable to communicate with external networks;
a router disposed in the housing and interfaced with the modem and the wireless access point, the router operable to route information from information handling systems of the local area network through the modem to the external networks; and
a print server disposed in the housing, the print server operable to communicate with the print controller and router to schedule print requests.
